(19) United States
(12) Patent Application Publication
(10) Pub. No.: US 2019/0171378 A1
(43) Pub. Date: Jun. 6, 2019

(54) MEMORY DEVICE, MEMORY CONTROLLER, AND STORAGE DEVICE INCLUDING THE SAME

(71) Applicant: SAMSUNG ELECTRONICS CO., LTD., Suwon-si (KR)

(72) Inventors: In-su KIM, Yongin-si (KR); Sang-wook NAM, Seoul (KR); Jong-min KIM, Seoul (KR); Jin-seok KIM, Seoul (KR)

(73) Assignee: SAMSUNG ELECTRONICS CO., LTD., Suwon-si (KR)

(21) Appl. No.: 16/128,841

(22) Filed: Sep. 12, 2018

(30) Foreign Application Priority Data
Dec. 6, 2017 (KR) 10-2017-0166646

(51) Int. Cl. G06F 3/06

(52) U.S. Cl. CPC G06F 3/0629; G06F 3/0688; G06F 3/0626; G06F 3/0611; G06F 3/0653

(57) ABSTRACT

Provided are a controller and a memory device. The memory device may include: a plurality of memory chips distinguished from one another by their corresponding chip numbers; and a monitor circuit including a plurality of first connection terminals electrically connected to the plurality of memory chips and configured to receive status information about a ready status and a busy status of each of the plurality of memory chips from the plurality of memory chips via the plurality of first connection terminals. The monitor circuit may output a plurality of packets each including a chip number and the status information corresponding to at least one of the plurality of memory chips.

### CROSS-REFERENCE TO RELATED APPLICATION

This application claims priority from Korean Patent Application No. 10-2017-0166646, filed on Dec. 6, 2017 in the Korean Intellectual Property Office, the disclosure of which is incorporated herein in its entirety by reference.

### BACKGROUND

### 1. Field

Apparatuses and methods consistent with example embodiments relate to a storage device, and more particularly, to a memory device, a memory controller, and a storage device including the same.

### 2. Description of the Related Art

Flash memories as non-volatile memories maintain stored data even when power is cut off. Because flash memories have a fast programming and erasing speed and large capacity, storage devices including flash memories, such as solid-state drives (SSDs) and memory cards, have been widely used.

As semiconductor technology continues to improve, the number of memory chips in a memory device increases, and there is a need for detecting a busy or ready status of each of the memory chips using a controller.

### SUMMARY

One or more example embodiments provide a controller and a memory device, i.e., a controller and a memory device that may transmit/receive a packet including information about a status of each of memory chips.

According to an aspect of an example embodiment, there is provided a memory device including: a plurality of memory chips distinguished from one another by their corresponding chip numbers; and a monitor circuit including a plurality of first connection terminals electrically connected to the plurality of memory chips and configured to receive status information about a ready status and a busy status of each of the plurality of memory chips from the plurality of memory chips via the plurality of first connection terminals. The monitor circuit may output a plurality of packets each including a chip number and the status information corresponding to at least one of the plurality of memory chips.

According to an aspect of an example embodiment, there is provided a controller including: a control logic circuit configured to output one or more control signals to a memory device including a plurality of memory chips; a packet interface configured to receive a packet including status information and a chip number corresponding to at least one of the plurality of memory chips from the memory device; and a background processor including a packet receiver configured to receive the packet from the packet interface and to output status information about at least one of the plurality of memory chips to the control logic circuit based on the packet.

According to an aspect of an example embodiment, there is provided a memory device including: a plurality of memory chips distinguished from one another by their corresponding chip numbers; and a monitor circuit including a plurality of first connection terminals electrically connected to the plurality of memory chips in one-to-one correspondence and a packet generator configured to receive status information about each of the plurality of memory chips from the plurality of first connection terminals. The packet generator may be further configured to generate a plurality of packets each including a chip number and the status information. The monitor circuit may be configured to output the plurality of packets based on a predetermined condition.

### BRIEF DESCRIPTION OF THE DRAWINGS

The above and/or other aspects will be more clearly understood from the following detailed description of example embodiments, taken in conjunction with the accompanying drawings in which:

FIG. 1 is a block diagram of a storage system according to an example embodiment;

FIGS. 2A through 2C are views for explain a configuration and an operation of a memory device according to an example embodiment;

FIG. 3 is a flowchart illustrating an operation of a monitor circuit according to an example embodiment;

FIGS. 4A and 4B are block diagrams illustrating examples of a configuration of the memory device according to an example embodiment;

FIGS. 5A and 5B are views for explaining an operation of the memory device according to an example embodiment;

FIGS. 6A and 6B are block diagrams of examples of a configuration of a controller according to an example embodiment;

FIG. 7 is a block diagram of an example of a background processor and a packet interface according to an example embodiment;

FIG. 8 is a flowchart illustrating an operation of the background processor according to an example embodiment;

FIG. 9 is a timing diagram of an operation of a controller and a memory device according to an example embodiment;

FIGS. 10A and 10B are views for explaining a configuration of a memory device according to an example embodiment;

FIG. 11 is a block diagram of a storage system according to an example embodiment; and

FIG. 12 is a block diagram of a server system and a network system including the controller and the memory device according to an example embodiment.

### DETAILED DESCRIPTION OF THE EMBODIMENTS

Reference will now be made in detail to example embodiments, with reference to the accompanying drawings. In the drawings, parts irrelevant to the description are omitted to clearly describe the exemplary embodiments, and like reference numerals refer to like elements throughout the specification. In this regard, the present exemplary embodiments may have different forms and should not be construed as being limited to the descriptions set forth herein.

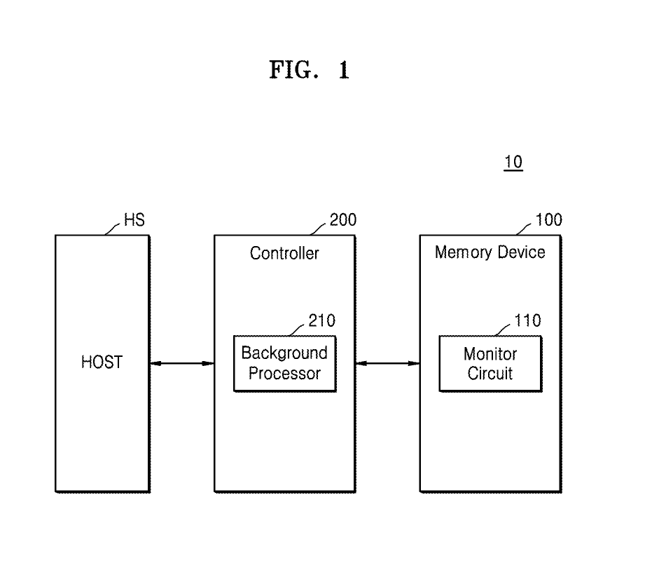

FIG. 1 is a block diagram of a storage system according to an example embodiment.

Referring to FIG. 1, a storage system 10 may include a host (HS), a memory device 100, and a controller 200. Elements illustrated in FIG. 1 may be a separate chip or device or may be included in one device. Also, the memory device 100 and the controller 200 may be implemented with one device or may be connected to the host HS.

The host HS may communicate with the controller 200 via various interfaces and may transmit a read request and a program request to the controller 200. In an example embodiment, the host HS may be implemented with an application processor (AP) or a system-on-chip (SoC).

The controller 200 may control the memory device 100 to read data stored in the memory device 100 in response to the read request from the host HS or to write data to the memory device 100. For example, the controller 200 may include a control logic circuit that outputs various control signals to the memory device 100 based on various requests of the host HS.

In an example embodiment, the controller 200 may include a background processor 210. The background processor 210 may receive a packet including information about a status of each of a plurality of memory chips included in the memory device 100 and a chip number of each memory chip. For example, the background processor 210 may output status information about each of the plurality of memory chips included in the memory device 100 to the control logic circuit based on the received packet. Thus, the controller 200 may receive the status information about each of the plurality of memory chips included in the memory device 100 via the packet output from the memory device 100 and may output various control signals regarding the plurality of memory chips based on the status information about each of the plurality of memory chips.

In an example embodiment, the background processor 210 may provide a predetermined condition for outputting a packet of the memory device 100 to the memory device 100. In an example, the condition for packet output of the memory device 100 may be whether a status of at least one of the memory chips included in the memory device 100 is changed from a busy status to a read status. In other words, a change in the status of the memory device 100 may trigger the packet output. In another example, the condition for packet output of the memory device 100 may be a packet being output for a predetermined time period. This will be described below in more detail.

The memory device 100 may include a plurality of memory chips for storing one or more pieces of data. For example, the plurality of memory chips may be distinguished from one another by their corresponding chip numbers. In other words, a chip number may be the corresponding chip's unique identifier.

In an example embodiment, the memory device 100 may include a monitor circuit 110. The monitor circuit 110 may output a packet including a chip number that corresponds to at least one of the plurality of memory chips and information about a status of each of the plurality of memory chips to the controller 200. For example, status information about each of the memory chips may include information about a ready and busy status of each of the memory chips.

Here, the busy status may mean a status in which a memory chip is in operation, for example, a status in which the memory chip is not able to perform a corresponding operation in spite of a request of the controller 200 because the memory chip is already engaged in another operation. Also, the ready status may mean a status of a memory chip that is ready to perform a corresponding operation in response to the request of the controller 200, for example.

In an example embodiment, the monitor circuit 110 may include a first connection terminal group electrically connected to the plurality of memory chips. The first connection terminal group may include a plurality of first connection terminals, and the plurality of memory chips may be connected to the plurality of first connection terminals in one-to-one correspondence, for example. The monitor circuit 110 may receive status information about a memory chip connected to a first connection terminal via the first connection terminal group.

In an example embodiment, the monitor circuit 110 may output the packet to the controller 200 based on a predetermined condition. In an example, the monitor circuit 110 may output the packet depending on whether information about a status of at least one of the memory chips is changed from a busy status to a ready status. In another example, the monitor circuit 110 may also output the packet based on a predetermined time period. A predetermined condition for packet output may be provided from the controller 200, for example.

The storage system 10 may be implemented with a personal computer (PC), a data server, a network-attached storage (NAS), an Internet of things (IoT) device, or a portable electronic device, for example. The portable electronic device may be a laptop computer, a mobile phone, a smartphone, a tablet PC, a personal digital assistant (PDA), an enterprise digital assistant (EDA), a digital still camera (DSC), a digital video camera, an audio device, a portable multimedia player (PMP), a personal navigation device (PND), an MP3 player, a handheld video game console, an e-book reader, a wearable device, or the like.

In an example embodiment, the memory device 100 and the controller 200 may be implemented with one storage device, and the storage device may be an internal memory embedded in the electronic device. For example, the storage device may be a solid-state drive (SSD), an embedded universal flash storage (UFS) memory device, or an embedded multi-media card (eMMC). In an example embodiment, the storage device may be an external memory that is detachably attached to the electronic device. For example, the storage device may be a UFS memory card, a compact flash (CF) card, a secure digital (SD) card, a micro secure digital (Micro-SD) card, a Mini-SD card, an extreme digital (xD) card, or a memory stick.

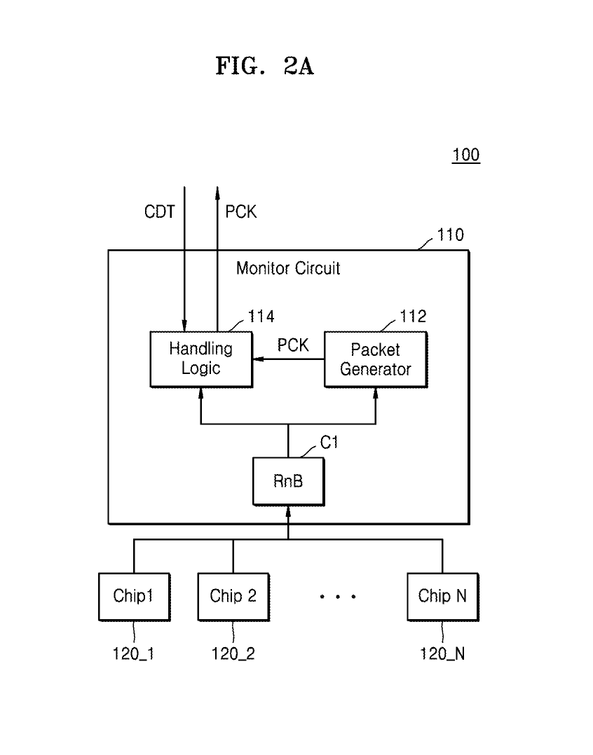

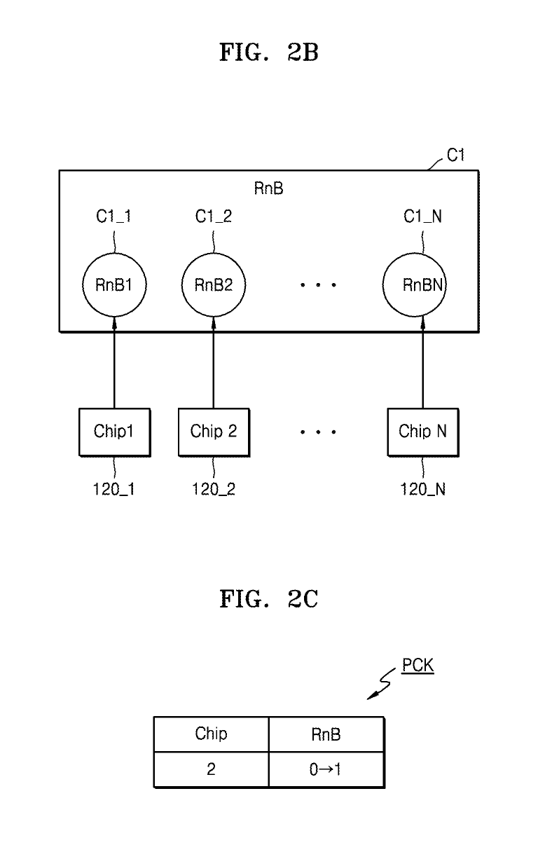

FIGS. 2A through 2C are views for explaining a configuration and an operation of a memory device according to an example embodiment. In more detail, FIG. 2A is a block diagram of the memory device 100, FIG. 2B is a block diagram illustrating connection between a plurality of memory chips 120_1 to 120_N and a first connection terminal group C1, and FIG. 2C illustrates a configuration of a packet (PCK). Hereinafter, FIGS. 2A through 2C will be described with reference to FIG. 1.

Referring to FIG. 2A, the memory device 100 may include the monitor circuit 110 and the plurality of memory chips 120_1 to 120_N. The memory chips 120_1 to 120_N may be distinguished from one another by first through N chip numbers. Here, N may be a positive integer and may be changed in various manners.

The plurality of memory chips 120_1 to 120_N may be flash memory chips including at least one memory block. However, embodiments are not limited thereto, and in another example embodiment, the plurality of memory chips 120_1 to 120_N may be phase change random access memory (PRAM) chips, ferroelectric RAM (FRAM) chips, or magnetic RAM (MRAM) chips that are non-volatile memory chips.

The monitor circuit 110 may include a packet generator 112, handling logic 114, and the first connection terminal group C1 including a plurality of first connection terminals. The various modules and components that are shown in FIG. 2A and other figures may be implemented with software (e.g., code, instructions, firmware, etc.), hardware (e.g., circuits, microchips, processors, etc.), or a combination of both. In an example embodiment, the plurality of first connection terminals of the first connection terminal group C1 may be electrically connected to the memory chips 120_1 to 120_N.

Referring to FIG. 2B, the first connection terminal group C1 may include a plurality of first connection terminals C1_1 to C1_N. In an example embodiment, the first connection terminals C1_1 to C1_N may be connected to the memory chips 120_1 to 120_N in one-to-one correspondence. In the example embodiment, the number of first connection terminals C1_1 to C1_N and the number of memory chips 120_1 to 120_N may be the same. However, embodiments are not limited thereto and there may be fewer or more connection terminals than the memory chips.

Each of the first connection terminals C1_1 to C1_N may be referred to as a pad or pin. For example, each of the first connection terminals C1_1 to C1_N and each of the memory chips 120_1 to 120_N may be hardwired to each other.

In an example embodiment, the monitor circuit 110 may receive status information about a memory chip connected to a corresponding one of each of the first connection terminals via the first connection terminals C1_1 to C1_N. For example, the monitor circuit 110 may receive status information about a first memory chip 120_1 from the first connection terminal C1_1 and may receive status information about an N-th memory chip 120_N from an N-th connection terminal C1_N, respectively. The status information may include information about a ready/busy status of each memory chip, for example.

Referring back to FIG. 2A, the packet generator 112 may receive status information about each of the memory chips 120_1 to 120_N via the first connection terminal group C1. In an example embodiment, the packet generator 112 may generate a packet PCK based on the received status information and chip number. In an example, each packet PCK generated by the packet generator 112 may include a chip number and status information about a memory chip that corresponds to the chip number. For example, the packet PCK may include a plurality of bits.

Further referring to FIG. 2C, for example, in the case of a packet regarding a second memory chip 120_2, a chip number ‘2’ and status information about the second memory chip 120_2 may be included in the packet generator 112. For example, when status information is represented by a single bit and the bit indicating the status information is ‘0’, the second memory chip 120_2 may be in a busy status, and when the bit indicating the status information is ‘1’, the second memory chip 120_2 may be in a ready status. However, embodiments are not limited thereto, and when the bit indicating the status information is ‘1’, the second memory chip 120_2 may be in a busy status, and when the bit indicating the status information is ‘0’, the second memory chip 120_2 may be in a ready status. The status of the memory chip 120_2 may also be represented by two or more bits.

Referring back to FIG. 2A, the handling logic 114 may receive the packet PCK output from the packet generator 112. Also, the handling logic 114 may receive status information about each of the memory chips 120_1 to 120_N via the first connection terminal group C1. In an example embodiment, the handling logic 114 may output the packet PCK received from the packet generator 112 based on a predetermined condition. The predetermined condition may be included in configuration information CDT provided from outside the memory device 100. In an example, the configuration information CDT may be provided from the controller 200.

In an example, the handling logic 114 may output the packet PCK depending on whether status information about at least one of the memory chips 120_1 to 120_N is changed from a busy status to a ready status. In detail, the handling logic 114 may output the packet PCK including a chip number and status information about a memory chip having status information changed from the busy status to the ready status, from among the memory chips 120_1 to 120_N, to the controller 200.

In another example, the handling logic 114 may also output a packet PCK based on a predetermined time period. The predetermined time period may be included in the configuration information CDT, for example. In detail, the handling logic 114 may output the packet PCK corresponding to the respective memory chips 120_1 to 120_N repeatedly in the predetermined time period.

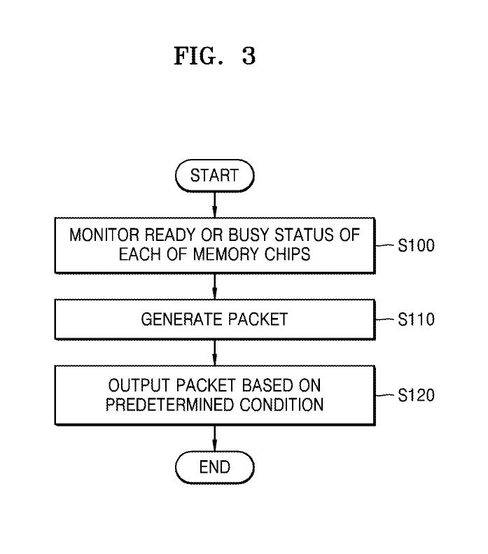

FIG. 3 is a flowchart for explaining an operation of a monitor circuit according to an example embodiment. FIG. 3 is a flowchart of an operation of the monitor circuit 110 of FIG. 2A, for example. Hereinafter, FIG. 3 will be described with reference to FIG. 2A.

Referring to FIG. 3, the monitor circuit 110 may monitor a ready or busy status of each of the memory chips 120_1 to 120_N (operation S100). For example, the handling logic 114 included in the monitor circuit 110 may monitor status information about each of the memory chips 120_1 to 120_N via the first connection terminal group C1.

Next, the monitor circuit 110 may generate a packet PCK (operation S110). For example, the packet generator 112 included in the monitor circuit 110 may receive status information about each of the memory chips 120_1 to 120_N via the first connection terminal group C1 and may generate the packet PCK based on the received status information and a chip number of each of the memory chips 120_1 to 120_N. In an example embodiment, the packet PCK may include a chip number and status information about a memory chip corresponding to the chip number.

In the flowchart, operation S110 is performed after operation S100 is performed. However, embodiments are not limited thereto. In other words, generation of the packet PCK may also be performed simultaneously with or prior to monitoring of a ready or busy status of each of the memory chips 120_1 to 120_N. The operations shown in FIG. 3 and other method figures may be performed in any order.

Next, the monitor circuit 110 may output the packet PCK based on a predetermined condition (operation S120). For example, the predetermined condition may be a predetermined condition included in the configuration information CDT provided from a controller (see 200 of FIG. 1). In an example embodiment, the handling logic 114 that receives the packet PCK generated by the packet generator 112 may output the packet PCK to a controller (see 200 of FIG. 1) based on the predetermined condition. In an example, the predetermined condition may be whether status information about at least one of the memory chips 120_1 to 120_N is changed from the busy status to the ready status. In another example, the predetermined condition may be outputting of the packet PCK based on the predetermined time period.

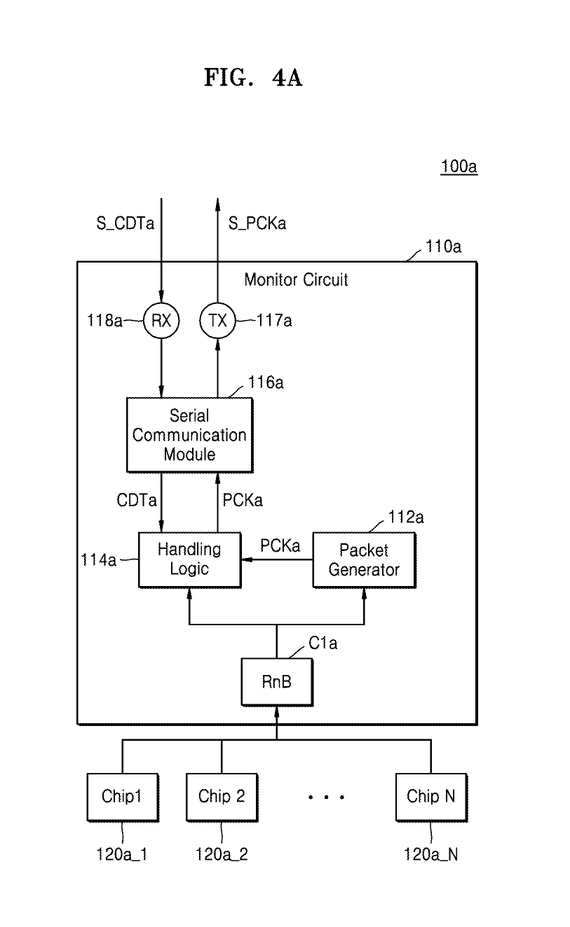

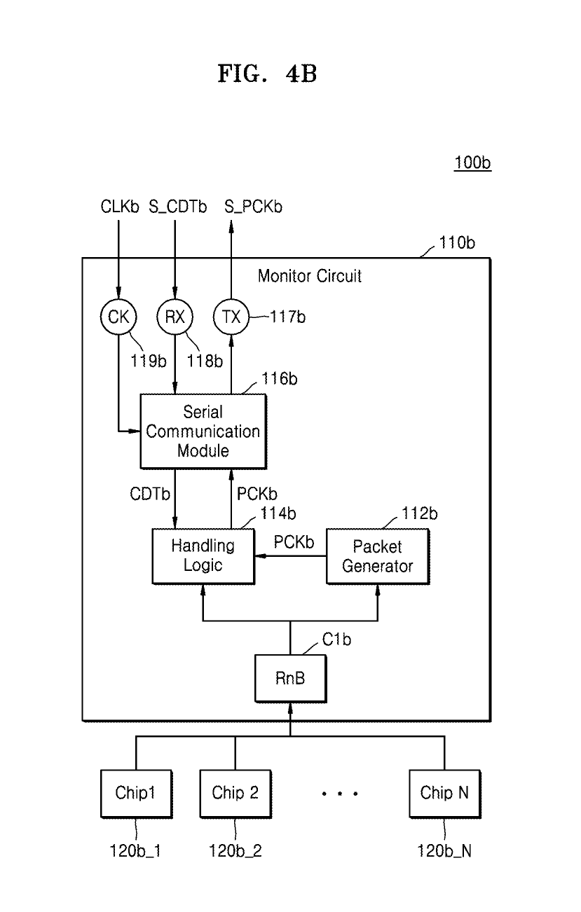

FIGS. 4A and 4B are block diagrams illustrating examples of a configuration of a memory device according to an example embodiment. A redundant description with FIG. 2A of the configuration of FIGS. 4A and 4B is omitted.

Referring to FIG. 4A, a monitor circuit 110a may further include a serial communication module 116a, a transmission terminal 117a, and a reception terminal 118a. The serial communication module 116a, the transmission terminal 117a, and the reception terminal 118a may be configured to perform communication between a controller (see 200 of FIG. 1) and the monitor circuit 110a.

In detail, the reception terminal 118a may receive serialized configuration information S_CDTa from the controller (see 200 of FIG. 1). The serial communication module 116a may deserialize the serialized configuration information S_CDTa received via the reception terminal 118a and may output configuration information CDTa to handling logic 114a.

Also, the serial communication module 116a may serialize the packet PCK received from the handling logic 114a and may output serialized packet S_PCKa to the controller (see 200 of FIG. 1) via the transmission terminal 117a. For example, the serial communication module 116a may include a serializing circuit and a deserializing circuit.

Referring to FIG. 4B, a monitor circuit 110b may further include a clock reception terminal 119b. A serial communication module 116b may receive a clock signal CLKb from the clock reception terminal 119b and may perform at least one of a deserializing operation of serialized configuration information S_CDTb and a serializing operation of a packet (PCKb) based on the clock signal CLKb. In an example, the serial communication module 116b may simultaneously perform the serializing operation and the deserializing operation in synchronization with the clock signal CLKb.

The clock signal CLKb may be provided from a clock generator within a memory device 100b. Alternatively, the clock signal CLKb may also be provided from outside the memory device 100b (for example, the controller 200 of FIG. 1).

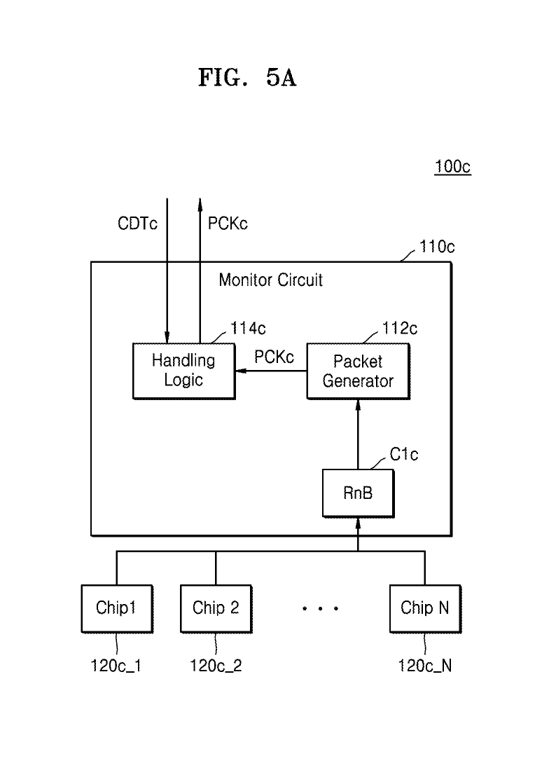

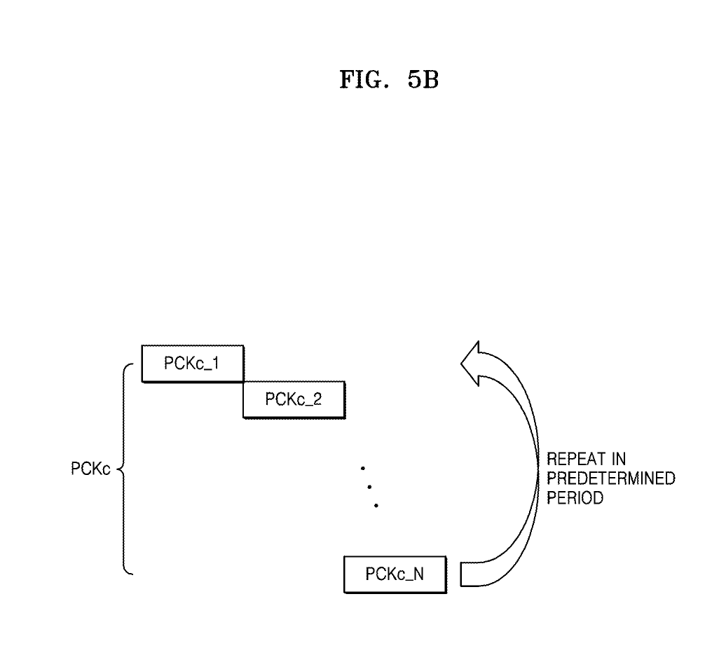

FIGS. 5A and 5B are views for explaining an operation of a memory device according to an example embodiment. In detail, FIG. 5A is a block diagram of a configuration of a memory device 100c, and FIG. 5B is a conceptual view for explaining output of a plurality of packets (PCKc). A redundant description with FIG. 2A of the configuration illustrated in FIGS. 5A and 5B is omitted.

Referring to FIG. 5A, a first connection terminal group C1c may be electrically connected to memory chips 120c_1 to 120c_N. A packet generator 112c may receive status information about each of the memory chips 120c_1 to 120c_N via the first connection terminal group C1c.

Handling logic 114c may receive the packet PCKc output from a packet generator 112c. Also, the handling logic 114c may receive configuration information CDTc from an outside of the memory device 100c. In an example, the configuration information CDTc may be provided to the controller (see 200 of FIG. 1).

In an example embodiment, the configuration information CDTc may include information about a predetermined period, and the handing logic 114c may output the packet PCKc based on the predetermined period. For example, the handling logic 114c may output the packet PCKc corresponding to the memory chips 120c_1 to 120c_N to the controller (see 200 of FIG. 1) repeatedly in the predetermined time period.

Further referring to FIG. 5B, the packet PCKc are output in the predetermined period. First through Nth packet PCKc_1 to PCKc_N that correspond to first through N-th memory chips 120c_1 to 120c_N may include chip numbers and status information about corresponding memory chips. As illustrated, the handling logic 114c may sequentially output the packet PCKc_1 to PCKc_N corresponding to the respective memory chips 120c_1 to 120c_N to the controller (see 200 of FIG. 1) repeatedly in the predetermined time period.

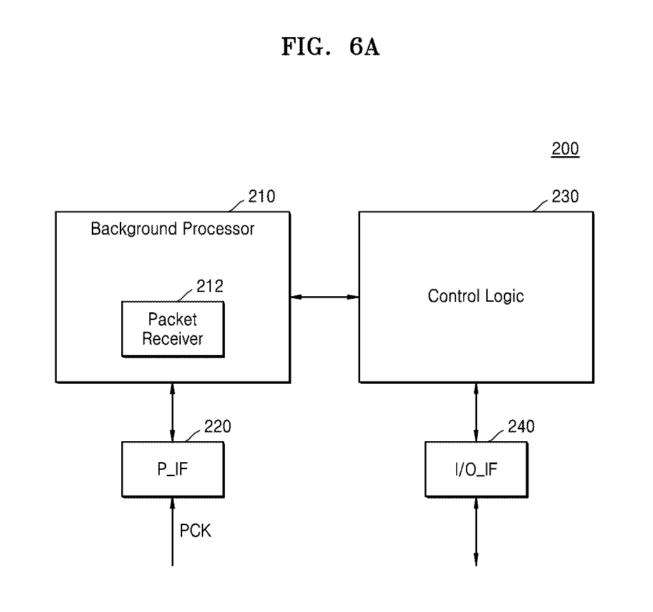

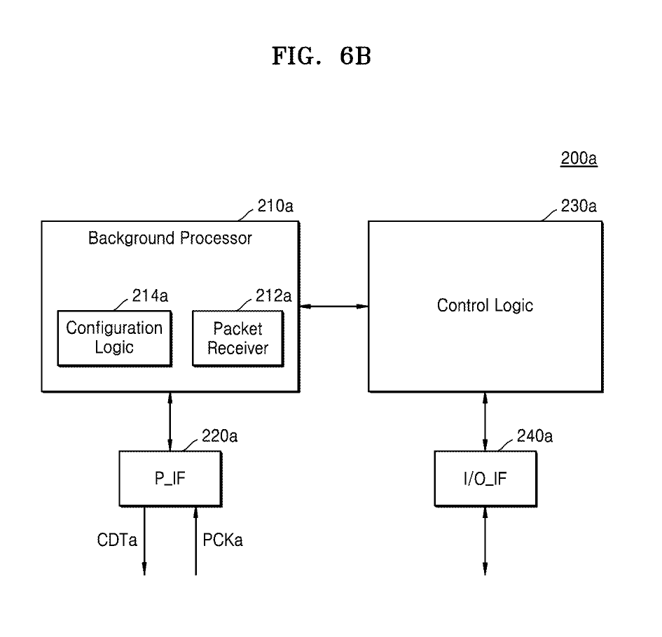

FIGS. 6A and 6B are block diagrams of examples of a configuration of a controller according to an example embodiment. Hereinafter, FIGS. 6A and 6B will be described with reference to FIG. 1.

Referring to FIG. 6A, a controller 200 may include a background processor 210, a packet interface 220, a control logic circuit 230, and an input/output interface 240. The controller 200 may further include elements, such as a processor, a host interface, an error correction code (ECC) module, a temperature sensor, and a bus.

The background processor 210 may include a packet receiver 212. The packet receiver 212 may receive a packet PCK provided from outside the controller 200 from the packet interface 220. For example, the packet PCK may be output from the memory device 100 connected to the controller 200 to communicate between the memory device 100 and the controller 200. The packet interface 220 as a separate element from the input/output interface 240 may be configured so that communication between the controller 200 and the memory device 100 may be performed. In an example embodiment, the packet PCK may include status information about each of the memory chips included in the memory device 100 and a chip number thereof. The status information may include information about a ready/busy status of each of the memory chips, for example.

The background processor 210 may provide the status information about each of the memory chips to the control logic circuit 230 based on the packet PCK. For example, the packet PCK transmitted by the memory device 100 may include a chip number of a memory chip having a ready status changed from a busy status from among the memory chips and bit information indicating that the memory device 100 is in the ready status. Thus, the background processor 210 may provide the information about the memory chip in the ready status to the control logic circuit 230.

The control logic circuit 230 may output various control signals to the memory device 100 and may control various operations of the memory chips included in the memory device 100. The control logic circuit 230 may output various control signals to the memory device 100 via the input/output interface 240 and may also receive data from the memory device 100. The input/output interface 240 may include a standard interface, such as an AT Attachment (ATA) interface, a Serial ATA (SATA) interface, a Parallel ATA (PATA) interface, a Universal Serial Bus (USB) interface, a Small Computer System Interface (SCSI), an Enhanced Small Disk Interface (ESDI), an Institute of Electrical and Electronics Engineers (IEEE) 1394 interface, an Integrated Drive Electronics (IDE) interface and/or a card interface.

In an example embodiment, the control logic circuit 230 may output various control signals to the memory device 100 based on status information about each of memory chips provided from the background processor 210. For example, when it is checked via the packet receiver 212 that a second memory chip (see 120_2 of FIG. 2) is changed from a busy status to a ready status, the control logic circuit 230 may output various control signals for controlling various operations of the second memory chip (see 120_2 of FIG. 2). In an example embodiment, the control logic circuit 230 may output a control signal to the memory device 100 via the input/output interface 240 and simultaneously may check status information about at least one of the memory chips via the packet receiver 212

The configuration of the controller 200a of FIG. 6B is similar to the configuration of the controller 200 described with reference to FIG. 6A. However, according to the current example embodiment, the background processor 210a may further include configuration logic 214a. The configuration logic 214a may output configuration information CDTa to the memory device 100 via the packet interface 220a.

In an example embodiment, the configuration information CDTa may include a predetermined condition as a base for output of a packet (PCKa) of the memory device 100. In an example, the configuration information CDTa may include a condition regarding whether status information about at least one of the memory chips is changed from a busy status to a ready status. In another example, the configuration information CDTa may include a predetermined time period as a condition. The configuration logic 214a may be implemented with firmware or software and may be loaded into a memory. However, embodiments are not limited thereto, and the configuration logic 214a may also be implemented with hardware.

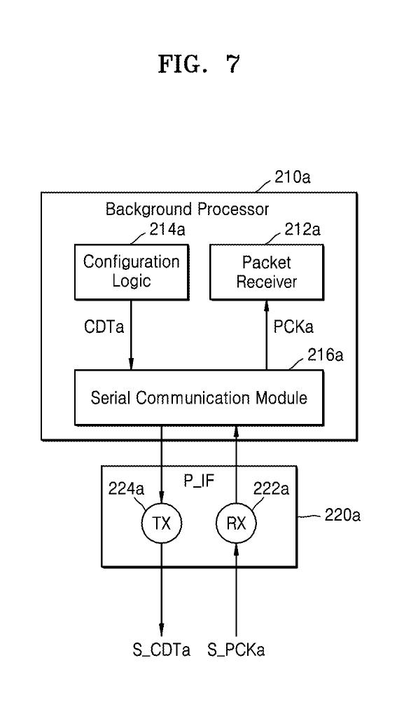

FIG. 7 is a block diagram for explaining an example of a background processor and a packet interface according to an example embodiment. For example, FIG. 7 is a block diagram of a detailed configuration of the background processor 210a and the packet interface 220a illustrated in FIG. 6B.

Referring to FIG. 7, the background processor 210a may include a serial communication module 216a. Also, a packet interface 220a may include a reception terminal 222a and a transmission terminal 224a. The serial communication module 216a, the reception terminal 222a, and the transmission terminal 224a may be configured so that communication between the controller 200a and a monitor circuit (see 110 of FIG. 1) of a memory device (see 100 of FIG. 1) may be performed.

In detail, the reception terminal 222a may receive a serialized packet S_PCKa from the monitor circuit (see 110 of FIG. 1). The serial communication module 216a may deserialize the serialized packet S_PCKa received by the reception terminal 222a and may output a packet (PCKa) to a packet receiver 212a.

Also, the serial communication module 216a may serialize configuration information CDTa received from a configuration logic 214a and may output serialized configuration information S_CDTa to the monitor circuit (see 110 of FIG. 1) via the transmission terminal 224a. For example, the serial communication module 216a may include a serializing circuit and a deserializing circuit.

In another example embodiment, the packet interface 220a may further include a clock reception terminal (not shown). For example, the serial communication module 216a may receive a clock signal from a clock reception terminal (not shown) and may perform at least one of a deserializing operation of a serialized packet S_PCKa and a serializing operation of the configuration information CDTa based on the clock signal. In an example, the serial communication module 216a may simultaneously perform the serializing operation and the deserializing operation in synchronization with the clock signal. The clock signal may be provided from a clock generator within the controller 200a or from outside the controller 200a.

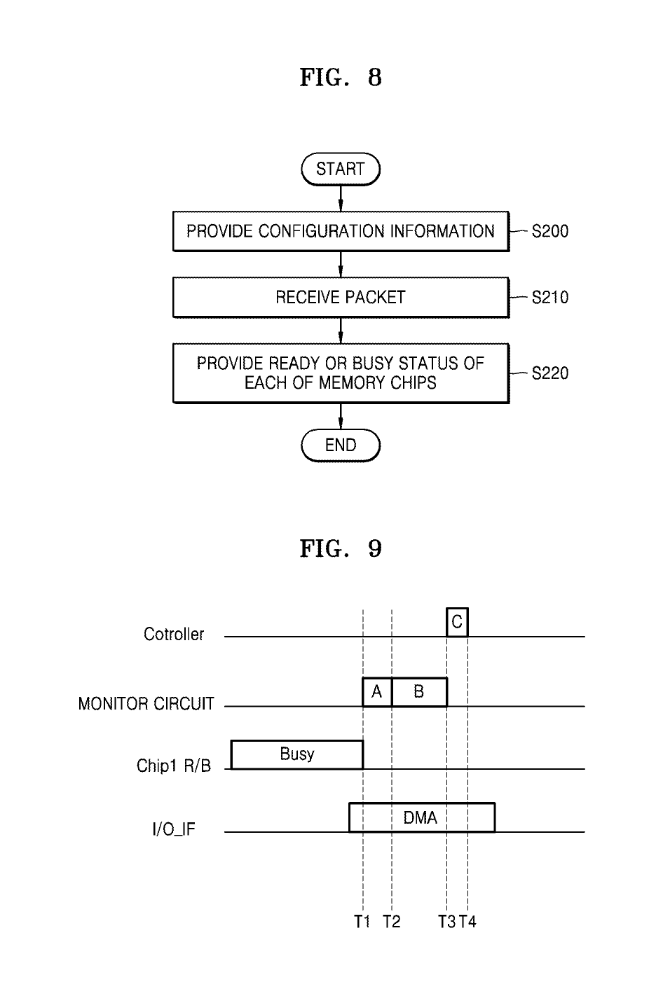

FIG. 8 is a flowchart for explaining an operation of a background processor according to an example embodiment. FIG. 8 is a flowchart of an operation of the background processor 210a of FIG. 6B, for example. Hereinafter, FIG. 8 will be described with reference to FIG. 6B.

Referring to FIG. 8, the background processor 210a may provide the configuration information CDTa to the monitor circuit (see 110 of FIG. 1) (operation S200). The configuration information CDTa may be provided to handling logic (see 114 of FIG. 2) placed in the monitor circuit (see 110 of FIG. 1), for example. In an example embodiment, the handling logic (see 114 of FIG. 2) that receives the configuration information CDTa may output the packet PCKa based on the configuration information CDTa.

Next, the background processor 210a may receive the packet PCKa output from the monitor circuit (see 110 of FIG. 1) (operation S210). The background processor 210a may receive the packet PCKa via the packet interface 220a separately from the input/output interface 240a. For example, the background processor 210a may output a control signal via the input/output interface 240 and may simultaneously receive the packet PCKa from the packet interface 220a. The packet PCKa may include status information about each of memory chips (see 120_1 to 120_N of FIG. 2) and a chip number thereof, for example.

Next, the background processor 210a may provide a ready or busy status of each of the memory chips to the control logic circuit 230a (operation S220). For example, when the monitor circuit (see 110 of FIG. 1) outputs the packet PCKa based on whether status information about the memory chip is changed from a busy status to a ready status, the background processor 210a may provide a chip number of the memory chip included in the packet PCKa to the control logic circuit 230a. Thus, the control logic circuit 230a may check the memory chip in the ready status and may output various control signals to the memory device (see 100 of FIG. 1) based on status information about the memory chip. In an example embodiment, operations S200 to S220 may be performed simultaneously with various control operations on the memory device (see 100 of FIG. 1) of the control logic circuit 230a via the input/output interface 240a.

FIG. 9 is a timing diagram of an operation of a controller and a memory device according to an example embodiment of the inventive concept. The timing diagram of FIG. 9 is a timing diagram of the operation of the controller and the memory device illustrated in FIGS. 1 through 8, for example. In FIG. 9, a first memory chip is illustrated. However, this is just for convenience of illustration, and embodiments are not limited thereto.

Referring to FIG. 9, a first memory chip (for example, see 120_1 of FIG. 2A, hereinafter referred to as 120_1) may be in a busy status until a first time T1. For example, the first memory chip (see 120_1 of FIG. 2A) may be in operation until the first time T1 and may not perform a corresponding operation in spite of a request of a controller (for example, see 200 of FIG. 6A, hereinafter referred to as 200).

At the first time T1, the first memory chip 120_1 may be changed from a busy status to a ready status. For example, at the first time T1, the first memory chip 120_1 may complete an operation being performed. In other words, the first memory chip 120_1 may be in a ready status in which it performs a corresponding operation in response to a request of the controller 200, from the first time T1.

Until a second time T2 after the first time T1, a monitor circuit (for example, see 110 of FIG. 2A, hereinafter referred to as 110) may monitor that the first memory chip 120_1 is changed from a busy state to a ready status (section A). For example, the handling logic (see 114 of FIG. 2A, hereinafter referred to as 114) placed in the monitor circuit 110 may monitor the first memory chip 120_1 via a first connection terminal group (see C1 of FIG. 2A, hereinafter referred to as C1) and thus may detect that the status of the first memory chip 120_1 is changed to the ready status.

Until a third time T3 after the second time T2, the monitor circuit 110 may transmit a packet (for example, see PCK of FIG. 2A, hereinafter referred to as PCK) including a chip number and status information about the first memory chip 120_1 may be transmitted to the controller 200 (section B). For example, the packet PCK may include at least one bit indicating that the first memory chip 120_1 is in a ready status. In an example embodiment, the packet PCK may be generated by a packet generator (see 112 of FIG. 2, hereinafter referred to as 112), and the handling logic 114 may output the packet PCK generated by the packet generator 112 based on a predetermined condition.

For example, the handling logic 114 may transmit the packet PCK corresponding to a memory chip having a status changed from a busy status to a ready status from among memory chips, to the controller 200. In an example embodiment, when detecting that the status of the first memory chip 120_1 is changed to the ready status, the handling logic 114 may transmit the packet PCK including the chip number and status information about the first memory chip 120_1 to the controller 200. In an example embodiment, the handling logic 114 may also transmit the packet PCK corresponding to each of the memory chips to the controller 200 during a predetermined period.

Until a fourth time T4 after the third time T3, the controller 200 that receives the packet PCK transmitted from the monitor circuit 110 may check whether the first memory chip 120_1 is in a ready status (section C). For example, the background processor (see 210 of FIG. 6A, referred to as 210) placed in the controller 200 may receive the packet PCK from a packet interface (see 220 of FIG. 6A, referred to as 220). The background processor 210 may transmit the ready status of the first memory chip 120_1 to a control logic circuit (see 230 of FIG. 6A, hereinafter referred to as 230) based on the received packet PCK. Thus, the control logic circuit 230 may control performing of various operations of the first memory chip 120_1 after the fourth time T4.

In an example embodiment, from the first time T1 to the fourth time T4, the control logic circuit 230 may control operations of other memory chips than the first memory chip 120_1 via the input/output interface (see 240a of FIG. 6A, hereinafter referred to as 240a). In an example, the control logic circuit 230 may output a direct memory access (DMA) control signal via the input/output interface 240a. However, embodiments are not limited thereto, and the control logic circuit 230 may also output various other control signals than the DMA control signal via the input/output interface 240a. In other words, the controller 200 may control various operations including a DMA operation of other memory chip than the first memory chip 120_1 and may simultaneously detect that the status of the first memory chip 120_1 is changed to the ready status.

According to the technical spirit of the present disclosure, the memory device 100 transmits information about a memory chip in a ready status to a controller at a time when the memory chip is in the ready status, so that deterioration of performance caused by unnecessary status checking repetition may be circumvented. Also, because the packet PCK is transmitted/received via a packet interface 220 separately from the input/output interface 240a, detecting of the status of the memory chip is performed simultaneously with other additional operations. Thus, the performance of the storage device may be improved. Also, because the controller may detect status information about the memory chip, detecting of the status of the memory chip may be implemented with a small number of gate counts (GC) and thus, the size of a chip may be reduced.

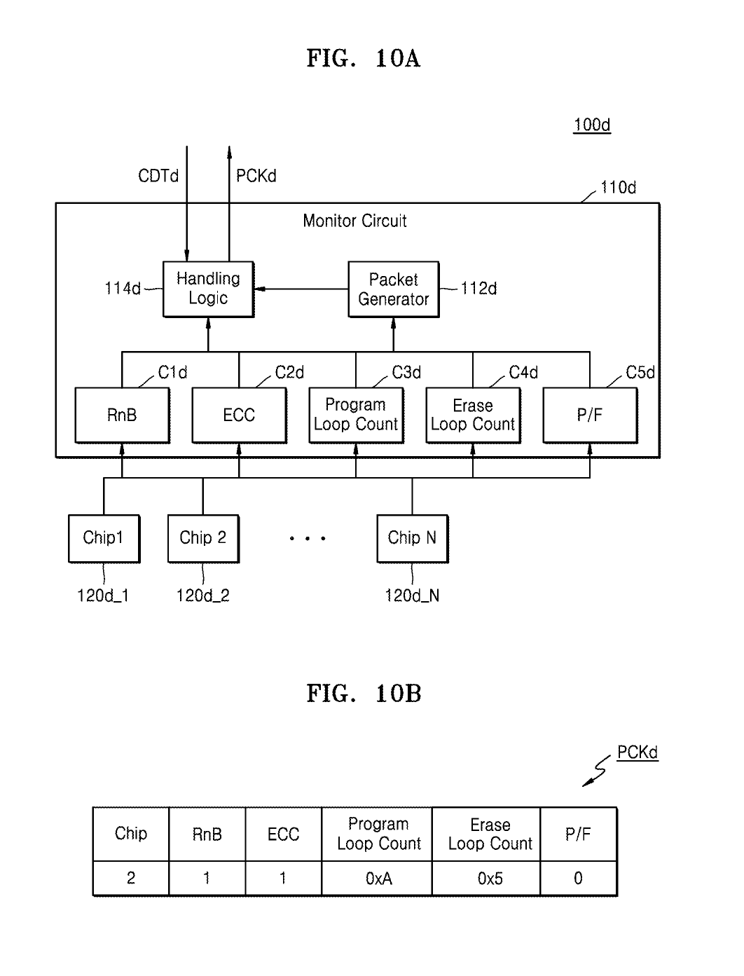

FIGS. 10A and 10B are views for explaining the configuration of a memory device according to an example embodiment. In detail, FIG. 10A is a block diagram of a memory device 100d, and FIG. 10B illustrates a configuration of a packet (PCKd). A redundant description with FIGS. 2A through 2C of the configuration illustrated in FIGS. 10A and 10B is omitted.

Referring to FIG. 10A, a monitor circuit 110d may further include second through fifth connection terminal groups C2d to C5d. The second through fifth connection terminal groups C2d to C5d may be electrically connected to the memory chips 120d_1 to 120d_N, respectively. In an example embodiment, the second through fifth connection terminal groups C2d to C5d may include a plurality of connection terminals that are connected to the memory chips 120d_1 to 120d_N in one-to-one correspondence. For example, the second through fifth connection terminal groups C2d to C5d may include a similar configuration to that of the first connection terminal group C1d.

The packet generator 112d may receive ECC result information about each of the memory chips 120d_1 to 120d_N via the second connection terminal group C2d. Also, the packet generator 112d may receive a program loop count and erase loop count information about each of the memory chips 120d_1 to 120d_N via the third and fourth connection terminal groups C3d and C4d. Also, the packet generator 112d may receive pass/fail (P/F) information about a program of data included in each of the memory chips 120d_1 to 120d_N via the fifth connection terminal group C5d.

In an example embodiment, the packet generator 112d may generate a packet (PCKd) based on at least one of received status information, ECC result information, the program/erase loop count, and the P/F information. In an example, each packet PCKd generated by the packet generator 12 may include a chip number, status information about a memory chip corresponding to the chip number, ECC result information, a program/erase loop count, and P/F information.

Further referring to FIG. 10B, for example, a packet about a second memory chip 120d_2, may include a chip number ‘2’, status information about the second memory chip 120d_2, P/F information, ECC result information, and program loop count and erase loop count information. For example, the status information, the P/F information, and the ECC result information may be represented by one bit. Also, the program loop count and erase loop count information may be represented as a plurality of bits represented by hexadecimal numbers.

Referring back to FIG. 10A, the handling logic 114d may receive ECC result information about each of the memory chips 120d_1 to 120d_N via the second connection terminal group C2d. Also, the handling logic 114d may receive program loop count and erase loop count information about each of the memory chips 120d_1 to 120d_N via the third and fourth connection terminal groups C3d and C4d. Also, the handling logic 114d may receive P/F information about a program of data included in each of the memory chips 120d_1 to 120d_N via the fifth connection terminal group C5d.

In an example embodiment, the handling logic 114d may be electrically connected to the first through fifth connection terminal groups C1d to C5d and receives all of the above-described information. However, the present disclosure is not limited thereto. That is, the handling logic 114d may be electrically connected to at least one of the first through fifth connection terminal groups C1d to C5d and may receive at least one of status information about each of the memory chips 120d_1 to 120d_N, ECC result, program loop count, erase loop count, and P/F information.

In an example embodiment, the handling logic 114d may output a packet (PCKd) received from the packet generator 112d based on a predetermined condition. The predetermined condition may be included in configuration information CDTd provided from outside the memory device 100. In an example, the configuration information CDTa may be provided by a controller (see 200 of FIG. 1).

In an example embodiment, when the packet PCKd includes the program loop count or erase loop count information, the controller (see 200 of FIG. 1) that receives the packet PCKd may check program loop count or erase loop count based on the packet PCKd. For example, the controller (see 200 of FIG. 1) may apply the program/erase loop count to execute defensive code.

In an example embodiment, when the packet PCKd includes ECC result information, the controller (see 200 of FIG. 1) that receives the packet PCKd, may determine whether performing of an ECC operation within the controller (see 200 of FIG. 1) is bypassed, based on the packet PCKd. In an example, if it is checked that there is no uncorrectable error, based on the ECC result information included in the packet PCKd, the controller (see 200 of FIG. 1) may bypass performing of the ECC operation within the controller (see 200 of FIG. 1).

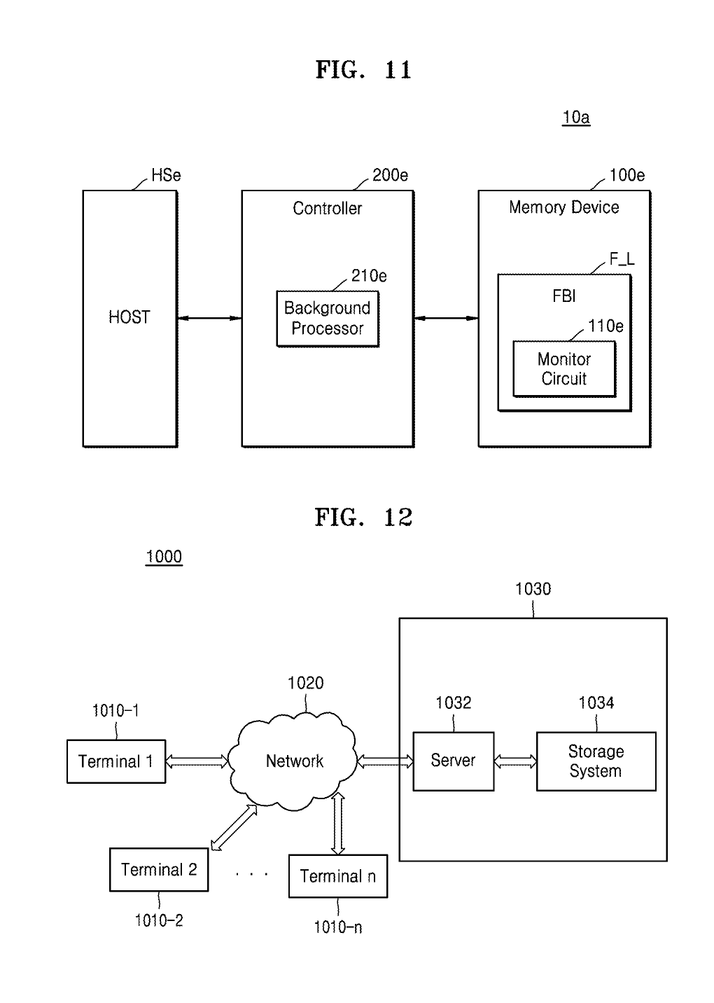

FIG. 11 is a block diagram of a storage system according to an example embodiment. A redundant description with FIG. 1 of the configuration of FIG. 11 is omitted.

Referring to FIG. 11, a memory device 100e may include a full block indicator (FBI)(F_L). For example, the FBI F_L may include a map table having mapping information recorded thereon by distinguishing position information about data stored in a memory device 100e by a logical unit. For example, the FBI F_L may be connected to an input/output interface (for example, see 240 of FIG. 6A) included in the controller 200e and may receive various control signals from the controller 200e. In an example, the FBI F_L may perform a page mapping operation without loading page mapping information from a meta region under a particular condition when a memory space for the page map table is small.

In an example embodiment, the monitor circuit 110e may be included in the FBI F_L. For example, the monitor circuit 110e may be connected to a packet interface (for example, see 220 of FIG. 6A) included in the controller 200e and may transmit a packet (for example, see PCK of FIG. 2) to the controller 200e. In an example embodiment, the packet PCK may include a chip number and status information about each of memory chips (for example, see 120_1 to 120_N of FIG. 2) included in the memory device 100e.

FIG. 12 is a block diagram of a server system and a network system including the controller and the memory device according to an example embodiment.

Referring to FIG. 12, a network system 1000 may include a plurality of terminals 1010-1 to 1010-n and a server system 1030, which are connected to one another via a network 1020. For example, the network system 1000 may mean a search portal or Internet data center (IDC). The plurality of terminals 1010-1 to 1010-n may be a PC, a laptop computer, a smartphone, a tablet PC, a PDA, a molded interconnection device (MID), a wearable computer, an IoT device, or an Internet-of-everything (IoE) device.

The plurality of terminals 1010-1 to 1010-n may communicate with the server system 1030 via the network 1020. The network 1020 may mean a wired network, a wireless network, the Internet, or a mobile phone network. The server system 1030 may include a server 1032 that processes requests received from the plurality of terminals 1010-1 to 1010-n connected to the network 1020, and a storage system 1034 for storing data corresponding to the requests received from the terminals 1010-1 to 1010-n. In this case, the storage system 1034 may include a controller and a memory device. Thus, the controller may check a memory chip having a completed operation without unnecessary repetition, and detecting of the memory chip in a ready status can be performed simultaneously with other operations.

While the present disclosure has been particularly shown and described with reference to example embodiments thereof, it will be understood that various changes in form and details may be made therein without departing from the spirit and scope of the following claims.

What is claimed is:

1. A memory device comprising:
a plurality of memory chips distinguished from one another by their corresponding chip numbers; and
a monitor circuit comprising a plurality of first connection terminals electrically connected to the plurality of memory chips and configured to receive status information about a ready status and a busy status of each of the plurality of memory chips from the plurality of memory chips via the plurality of first connection terminals,
wherein the monitor circuit is further configured to output a plurality of packets each comprising a chip number and the status information corresponding to at least one of the plurality of memory chips.

2. The memory device of claim 1, wherein the monitor circuit further comprises:
a packet generator configured to generate a packet of the plurality of packets based on the status information and the chip number received from the plurality of first connection terminals; and
handling logic configured to receive the packet from the packet generator and to output the packet based on a predetermined condition.

3. The memory device of claim 2, wherein the handling logic is further configured to receive the status information from the plurality of first connection terminals and output the packet based on whether the status information about at least one of the plurality of memory chips is changed from the busy status to the ready status.

4. The memory device of claim 2, wherein the handling logic is further configured to output the packet based on a predetermined time period.

5. The memory device of claim 2, wherein the handling logic is further configured to output the packet to a controller configured to control the memory device and receive the predetermined condition from the controller.

6. The memory device of claim 2, wherein the monitor circuit further comprises:
a reception terminal configured to receive the predetermined condition, which is serialized, from outside the memory device;
a serial communication module configured to deserialize the predetermined condition received via the reception terminal and to serialize the packet output from the handling logic; and
a transmission terminal electrically connected to the serial communication module,
wherein the serial communication module is further configured to output the serialized packet to the outside of the memory device via the transmission terminal.

7. The memory device of claim 6, wherein the monitor circuit further comprises a clock reception terminal configured to receive a clock signal from the outside of the memory device, and
wherein the serial communication module is further configured to perform at least one of a serializing operation and a deserializing operation based on the clock signal received by the clock reception terminal.

8. The memory device of claim 2, further comprising a plurality of second connection terminals electrically connected to the plurality of memory chips,
wherein the packet generator is further configured to receive error correction code (ECC) performance result information about each of the plurality of memory chips from the plurality of second connection terminals and generate the packet further based on the ECC performance result information.

9. The memory device of claim 2, further comprising a plurality of third connection terminals electrically connected to the plurality of memory chips,
wherein the packet generator is further configured to receive one of program loop count information and erase loop count information about each of the plurality of memory chips from the plurality of third connection terminals and generate the packet further based on the one of the program loop count information and the erase loop count information.

10. A controller comprising:
a control logic circuit configured to output one or more control signals to a memory device comprising a plurality of memory chips;
a packet interface configured to receive a packet comprising status information and a chip number corresponding to at least one of the plurality of memory chips from the memory device; and
a background processor comprising a packet receiver configured to receive the packet from the packet interface and to output status information about at least one of the plurality of memory chips to the control logic circuit based on the packet.

11. The controller of claim 10, wherein the packet comprises information about a ready status and a busy status of at least one of the plurality of memory chips, and the packet receiver is further configured to provide information about the ready status and the busy status of each of the plurality of memory chips to the control logic circuit.

12. The controller of claim 10, wherein the background processor further comprises configuration logic configured to output a predetermined condition for outputting the packet to the memory device.

13. The controller of claim 12, wherein the predetermined condition comprises a condition under which the packet is output based on whether the status information about at least one of the plurality of memory chips is changed from the busy status to the ready status.

14. The controller of claim 12, wherein the predetermined condition comprises a condition under which the packet is output based on a predetermined time period.

15. The controller of claim 12, wherein the packet interface further comprises:
a reception terminal configured to receive the packet, which is serialized, from the memory device; and
a transmission terminal,
wherein the background processor further comprises a serial communication module configured to deserialize the packet received by the reception terminal and to serialize the predetermined condition output from the configuration logic, and
wherein the serial communication module is further configured to output the predetermined condition to the memory device via the transmission terminal.

16. The controller of claim 10, further comprising an input/output interface,
wherein the control logic circuit is further configured to output the one or more control signals to the memory device via the input/output interface.

17. A memory device comprising:
a plurality of memory chips distinguished from one another by their corresponding chip numbers; and
a monitor circuit comprising a plurality of first connection terminals electrically connected to the plurality of memory chips in one-to-one correspondence and a packet generator configured to receive status information about each of the plurality of memory chips from the plurality of first connection terminals,
wherein the packet generator is further configured to generate a plurality of packets each comprising a chip number and the status information, and
wherein the monitor circuit is configured to output the plurality of packets based on a predetermined condition.

18. The memory device of claim 17, wherein the monitor circuit further comprises handling logic configured to receive the predetermined condition from a controller configured to control the memory device and to output the plurality of packets to the controller based on the predetermined condition.

19. The memory device of claim 18, wherein the handling logic is configured to receive status information about each of the plurality of memory chips via the first connection terminals.

20. The memory device of claim 18, wherein the monitor circuit further comprises a plurality of second connection terminals electrically connected to the plurality of memory chips in one-to-one correspondence,
wherein the packet generator is further configured to receive at least one of program loop count information and erase loop count information about each of the plurality of memory chips via the plurality of second connection terminals and generate the plurality of packets further comprising at least one of the program loop count information and the erase loop count information.
